(19) United States
(12) Patent Application Publication
(10) Pub. No.: US 2006/0002526 A1
(43) Pub. Date: Jan. 5, 2006

(54) Telephone switching equipment and switching network system

(76) Inventor: Nobuyuki Takeda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,287

(22) Filed: Jun. 30, 2005

(30) Foreign Application Priority Data
Jun. 30, 2004 (JP) P 2004-194936

(51) Int. Cl. H04M 11/00

(52) U.S. Cl. 379/90.01; 379/202.01

(57) ABSTRACT

A telephone switching equipment is connected to a plurality of telephone terminals via extension lines, and connected to a plurality of central office lines each having a plurality of communication channels. The telephone switching equipment includes: an acquisition unit that, when a request to use one of the central office lines is received, acquires first identification information to identify the central office line to be used and second identification information to identify the communication channel to be used; a recording unit that records the first and the second identification information acquired by the acquisition unit on a recording medium; and a management unit that manages the first and the second identification information recorded on the recording medium in association with each other.

### RELATED APPLICATIONS

The present disclosure relates to the subject matter contained in Japanese Patent Application No. 2004-194936 filed on Jun. 30, 2004, which is incorporated herein by reference in its entirety.

### BACKGROUND OF The INVENTION

1. Field of the Invention

The present invention relates to a telephone switching equipment that allows to conduct conference calling between telephone terminals connected to a digital service line such as an ISDN central office line, a switching network system for connecting a plurality of telephone switching equipments by a digital service line, and a method for controlling the telephone switching equipment.

2. Description of the Related Art

A related network system is configured as follows: For example, in an enterprise having a plurality of branches and business offices, a telephone switching equipment such as a PBX (Private Branch Exchange) or a key telephone gateway is installed in each of the branches and business offices and the telephone switching equipments are connected by a dedicated line. In a system configured above, inter-extension communications can be conducted and central office line outgoing and incoming calls through a public switched telephone network, etc., can be made for each telephone switching equipment. In addition, extension communications can be conducted between different telephone switching equipments, and central office line outgoing and incoming calls can be made via different telephone switching equipments.

In a system configured above, service for calling speakers on any other extension or a dedicated line from a specific extension terminal and conducting conference calling of three parties or more is also proposed. (For example, refer to JP-A-6-237303.) Conference calling may be conducted between extension terminals connected to a telephone switching equipment. (For example, refer to WO97/48233 and JP-A-6-006470.)

### SUMMARY OF The INVENTION

In the system described above, service for conducting conference calling between a terminal connected to the ISDN network and an extension terminal in the telephone switching equipment is also examined. In the telephone switching equipment, however, the ISDN central office line can be recognized, but a plurality of B channels in the ISDN central office line cannot be recognized. Thus, if two or more terminals are connected to the B channels in the ISDN central office line, when one B channel terminal is disconnected, which B channel is to be disconnected cannot be determined.

In the telephone switching equipment, when a call is monitored about the ISDN central office line, the B channel to be monitored cannot be recognized.

The present invention provides a telephone switching equipment, a switching network system, and a method for controlling a telephone switching equipment for effectively providing additional service involved in outgoing and incoming calls of conference calling service for the telephone terminal connected for each communication channel in a central office line.

According to a first aspect of the invention, there is provided a telephone switching equipment connected to a plurality of telephone terminals via extension lines, and connected to a plurality of central office lines each having a plurality of communication channels. The telephone switching equipment includes: an acquisition unit that, when a request to use one of the central office lines is received, acquires first identification information to identify the central office line to be used and second identification information to identify the communication channel to be used; a recording unit that records the first and the second identification information acquired by the acquisition unit on a recording medium; and a management unit that manages the first and the second identification information recorded on the recording medium in association with each other.

According to a second aspect of the invention, there is provided a switching network system including: a plurality of telephone switching equipments each connected to a plurality of telephone terminals via extension lines, and connected to a plurality of central office lines each having a plurality of communication channels; a digital service line that connects the telephone switching equipments with each other; an acquisition unit that, when a request to use one of the central office lines is received, acquires first identification information to identify the central office line to be used and second identification information to identify the communication channel to be used; a recording unit that records the first and the second identification information acquired by the acquisition unit on a recording medium; and a management unit that manages the first and the second identification information recorded on the recording medium in association with each other.

According to a third aspect of the invention, there is provided a method for controlling a telephone switching equipment connected to a plurality of telephone terminals via extension lines, and connected to a plurality of central office lines each having a plurality of communication channels. The method includes: acquiring first identification information to identify the central office line to be used and second identification information to identify the communication channel to be used, when a request to use one of the central office lines is received; recording the first and the second identification information acquired on a recording medium; and managing the first and the second identification information recorded on the recording medium in association with each other.

### BRIEF DESCRIPTION OF THE DRAWINGS

In the accompanying drawings,

FIG. 1 is a block diagram to show a telephone switching equipment system according to a first embodiment of the invention;

FIG. 2 is a block diagram to show the functional configuration of a CTI equipment in the first embodiment;

FIG. 3 is a drawing to show an example of the storage contents of RAM shown in FIG. 2;

FIG. 4 is a flowchart to show a control procedure of conference calling operation in the first embodiment;

FIG. 5 is a flowchart to show a control procedure of monitor operation in the first embodiment;

FIG. 6 is a drawing to show the schematic configuration of a switching network system according to a second embodiment of the invention; and

FIG. 7 is a block diagram to show the specific configuration of a telephone switching equipment in the second embodiment.

### DETAILED DESCRIPTION OF THE EMBODIMENTS

Hereinafter, embodiments of the invention will be described by reference to the drawings in detail.

### First Embodiment

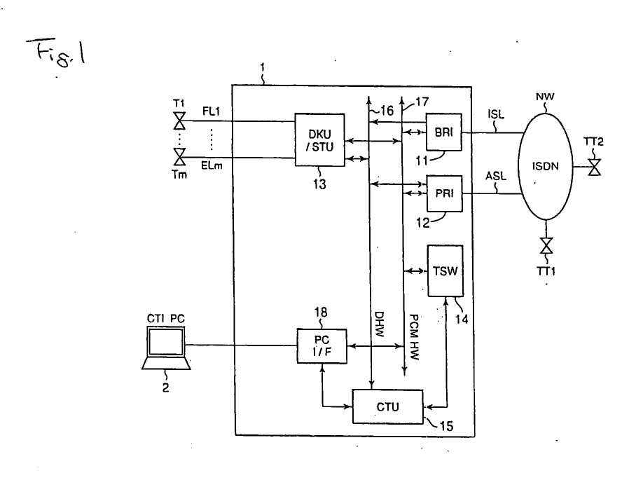

FIG. 1 is a block diagram to show a first embodiment of a telephone switching equipment system according to the invention. In the figure, numeral 1 denotes a telephone switching equipment (gateway).

The telephone switching equipment 1 includes different types of external line interface sections (BRI) 11 and (PRI) 12, a line interface section (DKU/STU) 13, a time switch (TSW) 14, and a central control section (CTU) 15, which are connected to each other by a control bus (DHW) 16. The external line interface sections 11 and 12, the line interface section 13, and the time switch 14 are connected to each other by a voice bus (PCMHW) 17.

The external line interface section (BRI) 11 is connected to an ISDN network NW through a central office line ISL (the number of B channels is two) corresponding to a basic rate interface of ISDN, and performs call establishment processing, etc., with the ISDN network NW in accordance with the basic rate interface. The external line interface section (PRI) 12 is connected to the ISDN network NW through a central office line ASL (the number of B channels is 23) corresponding to a primary rate interface of ISDN, and performs call establishment control, etc., with the ISDN network NW in accordance with the primary rate interface.

A plurality of extensions EL1 to ELm are accommodated in the line interface section 13 and extension terminals T1 to Tm are connected to the extensions EL1 to ELm respectively. For example, digital key telephones can be used as the extension terminals T1 to Tm. The line interface section 13 performs outgoing and incoming call processing, transfer processing of a digital signal, etc., for the extension terminals T1 to Tm.

The time switch 14 performs channel exchange of a digital signal transmitted through the voice bus 17 between the external line interface section 11, 12 and the line interface section 13 as instructed by the central control section 15.

The telephone switching equipment 1 in the first embodiment contains a computer connection interface section (PC I/F) 18. A CTI (Computer Telephony Integration) machine 2 is connected to the computer connection interface section 18. The computer connection interface section 18 has a function of performing transfer processing of a digital voice signal between the CTI equipment 2 and the voice bus 17 and a function of performing transfer processing of a control command, etc., between the central control section 15 and the CTI equipment 2.

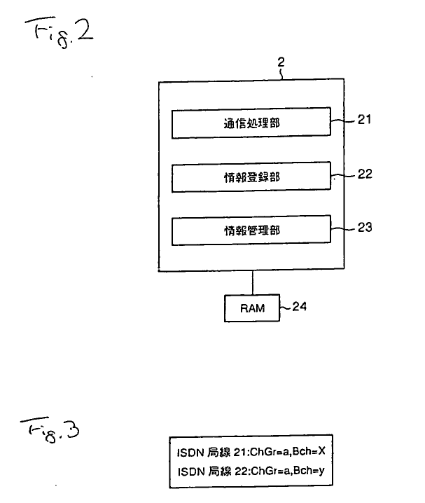

The CTI equipment 2 includes a communication processing section 21, an information registration section 22, and an information management section 23, as shown in FIG. 2, as the functions relating to the invention. For example, whenever connection request operation for allowing a terminal connected to the ISDN network NW to join conference calling is performed in the busy extension terminal T1, the communication processing section 21 communicates with the telephone switching equipment 1 to acquire channel group information to identify the ISDN central office line to which the terminal to be allowed to join the conference calling is connected and B channel information to identify the B channel in the ISDN central office line to be used.

The information registration section 22 registers the acquired channel group information and B channel information in RAM 24.

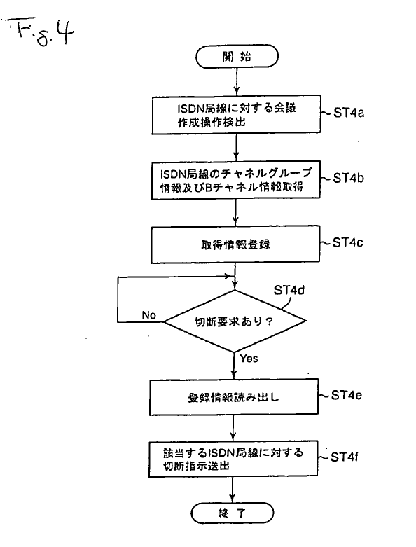

The information management section 23 manages the channel group information and the B channel information in the RAM 24 as shown in FIG. 3. When a disconnection request for the busy ISDN central office line occurs, the information management section 23 reads the channel group information and the B channel information corresponding to the ISDN central office line from the RAM 24 and transfers the channel group information and the B channel information to the telephone switching equipment 1 for executing disconnection processing for the ISDN central office line.

When a request to monitor the operation state of the busy ISDN central office line is sent from the telephone switching equipment 1, the information management section 23 reads the channel group information and the B channel information corresponding to the ISDN central office line from the RAM 24 and transfers the channel group information and the B channel information to the telephone switching equipment 1 for executing monitor processing for the ISDN central office line.

Further, the central control section 15 of the telephone switching equipment 1 also has a function of acquiring channel group information to identify the ISDN central office line and B channel information to identify the B channel in the ISDN central office line to be used and a function of recording and managing the acquired information in RAM (not shown) as the functions relating to the invention.

Next, the operation of the described system will be described in detail.

Conference Calling Operation

To begin with, assume that a telephone conversation is made between the extension terminal T1 and an external terminal TT1 connected to the ISDN network NW. In this state, assume that, for example, the user with the extension terminal T1 performs operation for allowing an external terminal TT2 on the ISDN network NW to join the conference calling. Then, request information is sent from the extension terminal T1 to the telephone switching equipment 1. Upon reception of the request information, while holding the communication link between the extension terminal T1 and the external terminal TT1, the telephone switching equipment 1 sends the request information to the external terminal TT2 via the ISDN central office line ASL for making an incoming call notification as ringing or incoming call indication. If the user of the external terminal TT2 responds to the incoming call notification, the external terminal TT2 on the ISDN network NW transmits a connection response signal to the telephone switching equipment 1.

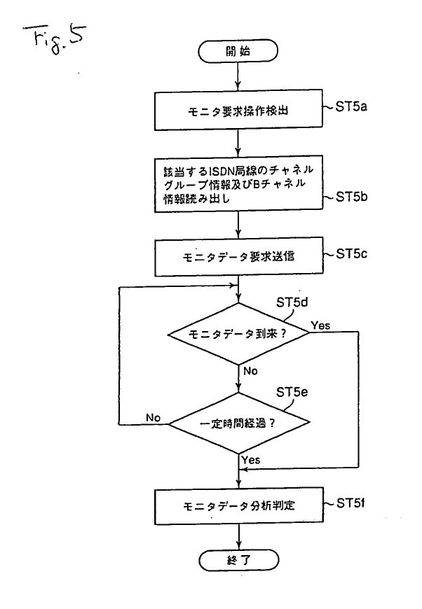

Thus, the external terminal TT2 can be allowed to join the conference calling between the extension terminal T1 and an external terminal TT1. At this time, the telephone switching equipment 1 detects the conference being created and sends the detection result to the CTI equipment 2. Upon reception of the detection result, the CTI equipment 2 executes a control procedure shown in FIG. 4.

That is, upon reception of the detection result (ST4a) the CTI equipment 2 acquires channel group information (a) and B channel information (x) of the external terminal TT2 allowed to join the conference calling by conducting communications with the telephone switching equipment 1 (step ST4b) and registers the acquired channel group information and B channel information in the RAM 24 (step ST4c).

The CTI equipment 2 checks whether or not a disconnection request for the external terminal TT1 or TT2 comes from the telephone switching equipment 1 (step ST4d) If a disconnection request for the external terminal TT2 comes (YES at step ST4d), the CTI equipment 2 reads the corresponding channel group information and B channel information from the RAM 24 (step ST4e) and sends disconnection command information to which the channel group information and the B channel information are added to the telephone switching equipment 1 (step ST4f).

Then, the telephone switching equipment 1 can disconnect the B channel (x) in the ISDN central office line ASL connecting the external terminal TT2 for placing the external terminal TT2 out of the conference calling.

Monitor Operation

Assume that, for example, an incoming call signal to the extension terminal T4 from the ISDN central office line ASL comes in the telephone switching equipment 1 in response to an outgoing call of the external terminal TT1. Then, the telephone switching equipment 1 transfers incoming data to the extension terminal T4 for making an incoming call notification.

At this time, the telephone switching equipment 1 transfers channel group information (a) and B channel information (y) of the busy ISDN central office line ASL to the CTI equipment 2. Assume that a request to monitor the busy ISDN central office line ASL is made in the extension terminal T3.

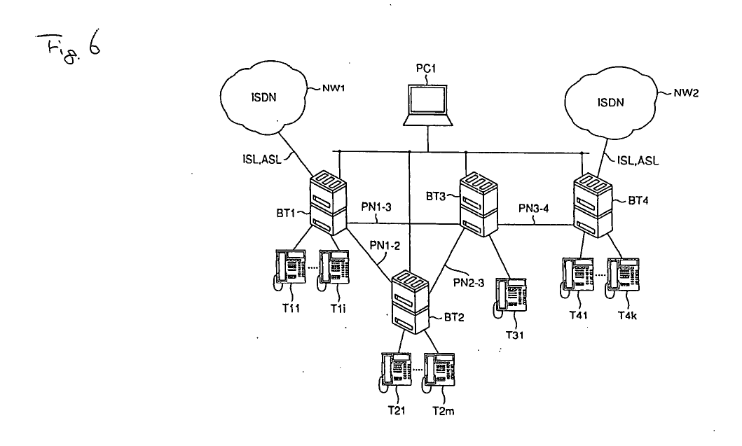

Then, the telephone switching equipment 1 detects the monitor request concerning the busy ISDN central office line and sends the detection signal to the CTI equipment 2. Then, the CTI equipment 2 executes control processing shown in FIG. 5.

First, the CTI equipment 2 receives the detection signal (step ST5a), reads the channel group information (a) and the B channel information (y) of the corresponding ISDN central office line ASL (step ST5b), and transmits a monitor data sending request to which the channel group information and the B channel information are added to the telephone switching equipment 1 (step ST5c). Then, the telephone switching equipment 1 monitors the corresponding ISDN central office line ASL based on the channel group information and the B channel information, and sends the most recent monitor data to the CTI equipment 2.

On the other hand, the CTI equipment 2 monitors monitor data coming from the telephone switching equipment 1 at step ST5d while monitoring the time passage at step ST5e after transmitting the monitor data sending request. When monitor data comes within a given time after transmission of the monitor data sending request, the CTI equipment 2 analyzes the received monitor data at step ST5f and determines whether or not an anomaly has occurred in the B channel (y) in the corresponding ISDN central office line ASL based on the analysis result. The CTI equipment 2 sends the determination result to the extension terminal T3 of the requester, for example.

As described above, in the first embodiment, when an outgoing or incoming call using the ISDN central office line ISL or ASL is made in the telephone switching equipment 1, the channel group information and the B channel information of the corresponding ISDN central office line are transferred to the CTI equipment 2, which then registers the transferred channel group information and B channel information in the RAM 24 for management.

Therefore, for example, if a disconnection request specifying the external terminal TT2 occurs during conference calling among the external terminal TT2 connected to the ISDN central office line ASL, the extension terminal T1 connected to the extension EL1, and the external terminal TT1, the B channel of the ISDN central office line ASL to be disconnected can be determined based on the channel group information and the B channel information in the RAM 24. Accordingly, any desired B channel in the ISDN central office line ASL can be disconnected.

In the first embodiment described above, when a monitor request for the busy ISDN central office line ISL occurs, the use state can be monitored for each B channel based on the channel group information and the B channel information in the RAM 24 of the CTI equipment 2.

Further, according to the first embodiment described above, a plurality of pieces of channel group information and B channel information of the busy ISDN central office line ASL can be intensively stored in the RAM 24 included in the CTI equipment 2 for management, so that the processing load on the telephone switching equipment 1 can be decreased.

### Second Embodiment

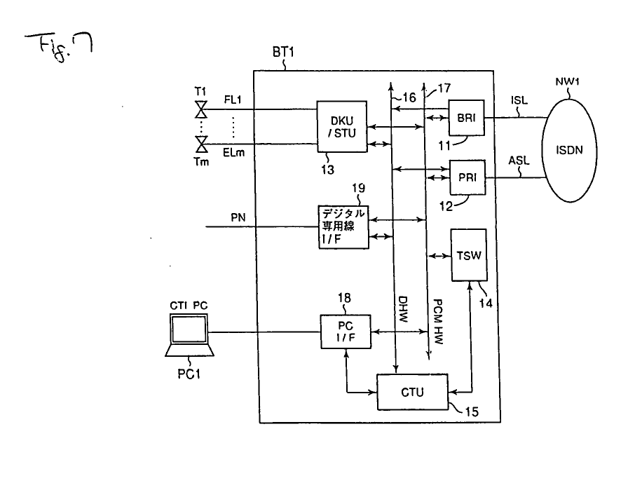

FIG. 6 is a drawing to show the schematic configuration of a switching network system according to a second embodiment of the invention.

As shown in the figure, the system includes telephone switching equipment BT1 to BT4, and the telephone switching equipment BT1 to BT4 are connected by digital service lines PN (PN1-2, PN1-3, PN2-3, and PN3-4) each having a communication channel (Bch) and a control channel (Dch). The telephone switching equipment BT1 to BT4 accommodate extension terminals T11 to T1i, T21 to T2m, T31, and T41 to T4k via extensions. The telephone switching equipment BT1 and BT4 are connected to ISDN networks NW1 and NW2 via ISDN central office lines ISL and ASL.

A CTI equipment PC1 is connected to the telephone switching equipment BT1 to BT4 through a LAN (Local Area Network). The CTI equipment PC1 has the same function as the CTI equipment 2 in the first embodiment and manages channel group information and B channel information in RAM 24 in association with the telephone switching equipment BT1 and BT4 connected to the ISDN networks NW1 and NW2.

Next, the specific configuration of the telephone switching equipment BT1 to BT4 will be discussed in detail with reference to FIG. 7. Parts identical with those previously described with reference to FIG. 1 are denoted by the same reference numerals in FIG. 7 and will not be discussed again in detail. Here, the telephone switching equipment BT1 will be discussed as a representative.

That is, the telephone switching equipment BT1 is provided with a digital service line interface (I/F) section 19. A digital service line PN is connected to the digital service line interface section 19 as required. The digital service line interface section 19 performs the digital service line interface operation concerning the connected digital service line PN. The digital service line interface operation involves transmission of an outgoing call signal to the digital service line PN, detection of an incoming call signal from the digital service line PN, etc. The digital service line interface section 19 transfers various pieces of control information involved in the digital service line interface operation to and from a central control section 15 via a control bus 16.

Thus, in the second embodiment, if conference calling is made among the different telephone switching equipment BT1 to BT4 using the ISDN central office lines ISL, ASL, when a disconnection request specifying an external terminal connected to the ISDN central office line ISL, ASL occurs, the B channel in the ISDN central office line ISL, ASL to be disconnected can be determined based on the channel group information and the B channel information managed in the CTI equipment PC1, so that appropriate disconnection processing can be executed for each B channel.

In the second embodiment described above, the channel group information and the B channel information of the busy ISDN central office line can be intensively stored in the RAM 24 included in the CTI equipment PC1 for management, so that the processing load on each of the telephone switching equipment BT1 to BT4 can be decreased.

### Miscellaneous Embodiments

The invention is not limited to the specific embodiments described above. For example, in the description of the embodiments, the acquisition function, the registration function, and the management function of the channel group information and the B channel information are executed in the CTI equipment by way of example, but may be executed in the telephone switching equipment or may be executed in any other apparatus connected to the telephone switching equipment.

The description of the first embodiment covers the conference calling and the monitor operation, but any other service requested for each B channel of the ISDN central office line may be executed.

It is to be understood that various modifications and changes of the system configuration and type, the configuration of the telephone switching equipment, the types of identification information such as the channel group information and the B channel information, the execution procedure of the service, etc., may be made without departing from the spirit and the scope of the invention.

As descried in detail with reference to the embodiments, according to the switching network system, when a request to use one of the ISDN central office lines occurs, the first identification information to identify the ISDN central office line to be used and the second identification information to identify the communication channel in the ISDN central office line to be used are acquired, and the first identification information and the second identification information are managed on the recording medium. Therefore, the communication channel in the busy ISDN central office line can be determined, so that appropriate service processing can be executed for each communication channel.

According to the telephone switching equipment, for example, when a disconnection request specifying a telephone terminal connected to the ISDN central office line during conference calling among two or more telephone terminals connected to the ISDN central office line and a telephone terminal connected to an extension, the communication channel in the ISDN central office line to be disconnected can be determined based on the first and second identification information on the recording medium. Accordingly, any desired communication channel in the ISDN central office line can be disconnected.

According to the telephone switching equipment, when a monitor request for the busy central office line occurs, the use state can be monitored for each communication channel based on the first and second identification information on the recording medium.

According to the telephone switching equipment, a plurality of pieces of the first and second identification information of the busy ISDN central office lines can be intensively stored on the recording medium included in the computer for management, so that the processing load on each telephone switching equipment can be decreased.

According to the switching network system, when a plurality of telephone switching equipments are provided, the first and second identification information of the busy ISDN central office line and each telephone switching equipment are managed in association with each other, whereby the communication channel of the ISDN central office line can be determined to execute service for each telephone switching equipment. Thus, for example, to share one system by a plurality of companies or individuals, the communication channel of the ISDN central office line to be used can be recognized for each company or individual, so that optimum service processing can be executed for each company or individual.

According to the switching network system, when conference calling is made among the different telephone switching equipments using the ISDN central office lines, when a disconnection request specifying a telephone terminal connected to the ISDN central office line occurs, the communication channel in the ISDN central office line to be disconnected can be determined based on the first and second identification information managed on the recording medium, so that appropriate disconnection processing can be executed for each communication channel.

According to the switching network system, the first and second identification information of the busy ISDN central office line can be intensively stored on the recording medium included in the computer for management, so that the processing load on each telephone switching equipment can be decreased.

As described above in detail, according to the invention, there is provided the telephone switching equipment, the switching network system, and a method for controlling the telephone switching equipment for effectively providing additional service involved in outgoing and incoming calls of conference calling service, etc., for the terminal connected for each communication channel in a central office line.

The invention is not absolutely limited to the embodiments. In an execution phase, constituent parts can be modified to give a shape to the invention without departing the scope and sprit thereof. In addition, various inventions can be formed by suitable combinations of a plurality of constituent parts disclosed in the aforementioned embodiment. For example, some constituent parts may be deleted from the whole constituent parts disclosed in the embodiment. Further, constituent parts in different embodiments may be combined suitably.

What is claimed is:

1. A telephone switching equipment connected to a plurality of telephone terminals via extension lines, and connected to a plurality of central office lines each having a plurality of communication channels, the telephone switching equipment comprising:
an acquisition unit that, when a request to use one of the central office lines is received, acquires first identification information to identify the central office line to be used and second identification information to identify the communication channel to be used;
a recording unit that records the first and the second identification information acquired by the acquisition unit on a recording medium; and
a management unit that manages the first and the second identification information recorded on the recording medium in association with each other.

2. The telephone switching equipment according to claim 1, wherein when a service request for the central office line that is in use is received, the recording unit reads from the recording medium the first and the second identification information corresponding to the central office line for which the service request is received, and
wherein the management unit performs control concerning service based on the first and the second identification information read by the recording unit.

3. The telephone switching equipment according to claim 2, wherein when a disconnection request for the central office line that is in use is received, the recording unit reads from the recording medium the first and the second identification information corresponding to the central office line for which the disconnection request is received, and
wherein the management unit performs disconnection processing for the central office line based on the first and second identification information.

4. The telephone switching equipment according to claim 2, wherein when as operation state monitor request for the central office line that is in use is received, the recording unit reads from the recording medium the first and the second identification information corresponding to the central office line for which the disconnection request is received, and
wherein the management unit performs monitor processing for the central office line based on the first and second identification information.

5. The telephone switching equipment according to claim 1 further comprising an interface for connecting a computer,
wherein the management unit communicates the first and the second identification information to and from the computer through the interface.

6. A switching network system comprising:
a plurality of telephone switching equipments each connected to a plurality of telephone terminals via extension lines, and connected to a plurality of central office lines each having a plurality of communication channels;
a digital service line that connects the telephone switching equipments with each other;
an acquisition unit that, when a request to use one of the central office lines is received, acquires first identification information to identify the central office line to be used and second identification information to identify the communication channel to be used;
a recording unit that records the first and the second identification information acquired by the acquisition unit on a recording medium; and
a management unit that manages the first and the second identification information recorded on the recording medium in association with each other.

7. The switching network system according to claim 6, wherein when a service request for the central office line that is in use is received, the recording unit reads from the recording medium the first and the second identification information corresponding to the central office line for which the service request is received, and
wherein the management unit performs control concerning service based on the first and the second identification information read by the recording unit.

8. The switching network system according to claim 7, wherein when a disconnection request for the central office line that is in use is received, the recording unit reads from the recording medium the first and the second identification information corresponding to the central office line for which the disconnection request is received, and
wherein the management unit performs disconnection processing for the central office line based on the first and second identification information.

9. The switching network system according to claim 7, wherein when as operation state monitor request for the central office line that is in use is received, the recording unit reads from the recording medium the first and the second identification information corresponding to the central office line for which the disconnection request is received, and
wherein the management unit performs monitor processing for the central office line based on the first and second identification information.

10. The switching network system according to claim 6 further comprising a computer connected to the telephone switching equipments and provided with the acquisition unit, the recording unit, and the management unit.

11. A method for controlling a telephone switching equipment connected to a plurality of telephone terminals via extension lines, and connected to a plurality of central office lines each having a plurality of communication channels, the method comprising:
acquiring first identification information to identify the central office line to be used and second identification information to identify the communication channel to be used, when a request to use one of the central office lines is received;
recording the first and the second identification information acquired on a recording medium; and
managing the first and the second identification information recorded on the recording medium in association with each other.
